(19) United States
(12) Patent Application Publication
(10) Pub. No.: US 2009/0164703 A1
(43) Pub. Date: Jun. 25, 2009

(54) FLEXIBLE FLASH INTERFACE

(75) Inventors: Gregory Racino, Austin, TX (US); Fuxiang Xiong, Suzhou (CN)

Correspondence Address: TUROCY & WATSON, LLP, 127 Public Square, 57th Floor, Key Tower, CLEVELAND, OH, 44114, US

(73) Assignee: SPANSION LLC, Sunnyvale, CA (US)

(21) Appl. No.: 11/963,241

(22) Filed: Dec. 21, 2007

(51) Int. Cl. G06F 12/02

(52) U.S. Cl. 711/103; 711/E12.008

(57) ABSTRACT

Systems and methods that can facilitate providing a flexible flash interface component that can accommodate communicating with almost any flash memory component (e.g., Open NAND Flash Interface (ONFI) compliant and ONFI noncompliant flash memory). A micro-operations component can contain one or more micro-operation that can be used to execute commands within the flash interface component. To facilitate a flexible flash interface, the micro-operations can include such commands as, but are not limited to, sending a command to the flash memory, sending a row address, sending a column address, transmit data (TXD), receive data (RXD), have the flash interface wait for a ready signal from the flash memory, read a status register from a flash memory, and/or provide an end of sequence (EOS) indication to the flash interface, for example.

### TECHNICAL FIELD

The subject innovation relates generally to memory systems and in particular, to systems and/or methodologies that can facilitate flexible data transfers to memory devices.

### BACKGROUND

A flash memory chip contains flash memory that is a type of electronic memory media that can be rewritten and can retain content without consumption of power. Flash memory has become popular, at least in part, because it combines the advantages of the high density and low cost of erasable programmable read only memory (EPROM) with the electrical erasability of electronically erasable programmable read only memory (EEPROM). Flash memory is non-volatile, which means that it can be rewritten and can hold its content without power. It can be used in many portable electronic products, such as cell phones, portable computers, voice recorders, thumbnail drives as well as many other types of products. The fact that flash memory can be rewritten as well as its retention of data without a power source, small size and light weight have all combined to make flash memory devices useful and popular means for transporting and maintaining data.

Many different companies and/or vendors design and fabricate flash memory chips, and also design and create various types of interfaces for the flash memory chips. However, having different flash memory chip interfaces has, for example, led to different types of flash memory protocols. For example, different flash interfaces can have different timing requirements associated with data transfers to and from the flash memory. Also, for instance, different flash memory chips can have different sets of low-level commands associated with controlling the communication associated with the different flash memory chips.

When a host initiates a data transfer with a flash memory chip, it can be required to store information regarding the various communication requirements associated with a particular flash memory chip so that the firmware associated with the flash interface can effectively communicate with that particular flash memory chip. Having different flash interfaces (e.g., flash interfaces that are not configurable) can increase the complexity and time-to-market of flash-based devices. The different flash memory protocols can also lead to incompatibility issues regarding future flash memory chips unless it is possible to update the flash interface firmware.

Because many flash memory utilize different flash interfaces that can be associated with many different protocols to effectively communicate with a host, it is desirable to develop and use a flash interface that can be versatile and configurable. Such an innovation can result in lower costs associated with flash interface designs due, in part, to the decreased amount of time it can require to debug the multitude of potential flash interfaces to accommodate the current and future flash memory chips that are and will be available on the market.

### SUMMARY

The following presents a simplified summary of the innovation in order to provide a basic understanding of some aspects described herein. This summary is not an extensive overview of the disclosed subject matter. It is intended to neither identify key or critical elements of the disclosed subject matter nor delineate the scope of the subject innovation. Its sole purpose is to present some concepts of the disclosed subject matter in a simplified form as a prelude to the more detailed description that is presented later.

The disclosed subject matter relates to systems and methods that relate to providing a flexible flash interface component that can accommodate communicating with flash memory components that adhere to the Open NAND Flash Interface (ONFI) standard along with being flexible enough to accommodate flash components that do not adhere to the ONFI standard. In accordance with one aspect of the disclosed subject matter, a register component can be programmed with a command sequence to facilitate communication between a flash interface component and one or more memory components. A command sequence can contain a series of micro-operations, wherein the micro-operations can represent various operation phases between the flash interface component and the memory component. Such a operation phases can include, but are not limited to, sending a command to the memory component, issuing an address cycle to send a row address to the memory component, issuing a cycle to send a column address to the memory component, transmitting data (TXD) to the memory component, receiving data (RXD) from the memory component, instructing the flash interface component to wait for a ready signal from the memory component, reading a status register from the memory component, and/or providing an end of sequence (EOS) indication to the flash interface component (e.g., indicating the last micro-operation has occurred), for example.

In accordance with one aspect of the disclosed subject matter, the flash interface component can accommodate a plurality of memory components. In one aspect, a command sequence can be configured to facilitate transactions with one or more of the plurality of flash memory component in parallel. One advantage of the disclosed subject matter is that it can facilitate efficient data transactions to one or more memory components because the flash interface component can send/receive data from one or more of the memory components simultaneously or substantially simultaneously (e.g., in parallel).

The following description and the annexed drawings set forth in detail certain illustrative aspects of the disclosed subject matter. These aspects are indicative, however, of but a few of the various ways in which the principles of the innovation may be employed and the disclosed subject matter is intended to include all such aspects and their equivalents. Other advantages and distinctive features of the disclosed subject matter will become apparent from the following detailed description of the innovation when considered in conjunction with the drawings.

### BRIEF DESCRIPTION OF THE DRAWINGS

FIG. 1 illustrates a block diagram of a system that facilitates transferring data to a memory in accordance with an aspect of the subject matter disclosed herein.

FIG. 2 depicts a block diagram of a system that facilitates the control of data flow associated with a memory in accordance with an aspect of the disclosed subject matter.

FIG. 3 illustrates a block diagram of a system that can facilitate the control of data to be transferred into a plurality of memory components in accordance with an aspect of the subject matter disclosed herein.

FIG. 4 illustrates a block diagram of a system that can facilitate buffering data from a plurality of memory components in accordance with an embodiment of the disclosed subject matter.

FIG. 5 illustrates a block diagram of a system that can facilitate data transfers to and from a plurality of memory components in accordance with an aspect of the subject matter.

FIG. 6 depicts a block diagram of a system that employs intelligence to facilitate transmission of data to a plurality of memory components in accordance with an aspect of the disclosed subject matter.

FIG. 7 depicts a block diagram of an example of a system that can store data in accordance with an embodiment of the disclosed subject matter.

FIG. 8 illustrates a methodology that facilitates controlling flash interface data flow in accordance with an aspect of the disclosed subject matter.

FIG. 9 depicts a methodology that facilitates programming a flash interface component based in part on memory component setup information in accordance with an aspect of the disclosed subject matter.

FIG. 10 depicts a methodology that facilitates transferring data to a memory component in accordance with an aspect of the disclosed subject matter.

FIG. 11 is a block diagram of an exemplary electronic device that can employ a flash memory component.

### DETAILED DESCRIPTION

The disclosed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the disclosed subject matter may be practiced without these specific details. In other instances, well-known structures and devices are shown in block diagram form in order to facilitate describing the subject innovation.

Traditionally, flash interface components can be “hard-wired” to facilitate communicating with the memory components that can be associated with the flash interface components. A hard-wired flash interface component can be a memory component interface constructed in hardware (e.g., via an integrated circuit (IC)). However, because of the many different memory components that can exist and the many different protocols that can be associated with the different memory components, a hard-wired flash interface component may not be able to accommodate every memory component on the market once the flash interface component is fabricated (e.g., new flash memory component protocols can become available that the hard-wired flash interface component is not designed to accommodate).

The disclosed subject matter provides a flexible interface approach that can maintain compatibility with Open NAND Flash Interface (ONFI) compliant memory components as well as other memory components that are not structured in accordance with the ONFI standard (e.g., a flash memory component developed prior to the ONFI standard). The ONFI standard provides that NAND devices can self-describe their capabilities to a host or flash interface component, including memory layout, timing support, and other enhanced features, for example. In accordance with one aspect of the disclosed subject matter, a micro-operations component can be utilized to setup a series of micro or phase operations for interactions between a host (e.g., computer, other flash memory component, digital camera, personal digital assistants (PDAs), global positioning system devices (GPSs)) and a flash interface component. The interactions can include, for example, sending and/or receiving data to a flash memory component and/or controlling a flash memory component. For example, such micro or phase operations can include, but are not limited to, sending a command to the memory component (CMD), issuing an address cycle to send a row address to the memory component, issuing a cycle to send a column address to a memory component, transmitting data to the memory component (TXD), receiving data from a memory component (RXD), instructing the flash interface component wait for a ready signal from the memory component, reading a status register from the memory component, generating an interrupt signal (IRQ) (e.g., to a processor), and/or providing an end of sequence indication to the flash interface component (EOS) (e.g., to indicate to the flash interface component that the last micro-operation has occurred). It is to be appreciated that the disclosed subject matter contemplates that as the ONFI and other standards develop, more micro-operations can be added to the available repertoire of micro-operations to accommodate the new developments in such standards.

In accordance with one aspect of the disclosed subject matter, the micro-operations can be written (e.g., via a processor component) to one or more registers located within the flash interface component. A series of micro-operations can be queued (e.g., into a command sequence) to be executed by the flash interface component. In one aspect, the flash interface component can cycle through the one or more of the registers to execute the micro-operations or command sequence contained therein. For example, the first micro-operations contained within the registers can be micro-operations that setup (CMD) a flash memory component associated with the flash interface component. Subsequent micro-operations can, for example, can be sending (TXD) and/or receiving (RXD) operations between a host and the memory component.

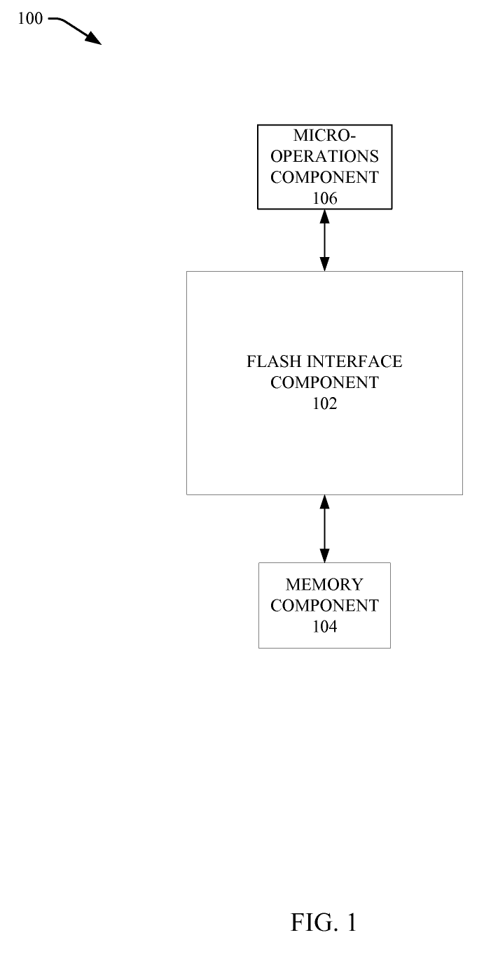

Turning to the figures, FIG. 1 illustrates a system 100 that can facilitate transferring data to a memory in accordance with an aspect of the disclosed subject matter. System 100 can include a flash interface component 102 that can be a control engine that can facilitate sending and receiving data and commands to a memory component 104 (e.g., by generating the pin protocol). The memory component 104 can be used to store data, and can comprise nonvolatile memory (e.g., flash memory) and/or volatile memory (e.g., static random access memory (SRAM)).

The system 100 can a include micro-operations component 106. The micro-operations component 106 can be a collection of software configurable communication commands (hereinafter also referred to as “micro-operation commands”) that can facilitate communication (e.g., transmitting and receiving data) with the memory component 104. Each individual micro-operation can be viewed, for example, as representing an instruction that can be similar to a processor instruction for facilitating communication with the memory component 104. In accordance with one aspect of the disclosed subject matter, the micro-operations component 106 can include such commands as a command for sending a command to the memory component 104 (CMD), issuing an address cycle to send a row address to the memory component 104, issuing a cycle to send a column address to the memory component 104, transmitting data (TXD) to the memory component 104, receiving data (RXD) from the memory component 104, instructing the flash interface component 102 to wait for a ready signal from the memory component 104, reading a status register from memory component 104, generating an interrupt (IRQ) signal (e.g., for a processor (not shown), and providing an end of sequence (EOS) indication to the flash interface component 102 (e.g., indicating the last micro-operation has occurred), for example. It is to be appreciated that the disclosed subject matter contemplates that the micro-operations component 106 is not limited to the micro-operation commands as described herein. For example, the micro-operations component 106 can contain virtually any number of micro-operation commands to accommodate data transmissions to and from the memory component 104.

In accordance with one aspect of the disclosed subject matter, a micro-operation can facilitate a multi-cycle operation with a memory component 104. For instance, an RXD micro-operation can instruct the flash interface component 102 to read data from a memory component 104 for a number of clock cycles (e.g., a sufficient number of clock cycles to finish the RXD). In some cases, a micro-operation can facilitate a single-cycle operation, for example a micro-operation that instructs the flash interface component 102 to send a single command (CMD) to the memory component 104.

The micro-operations component 106 can contain several or a series of micro-operations that can be performed to communicate with the memory component 104, wherein the series of micro-operations to be performed can be referred to as a command sequence. Typically, tasks (e.g., memory operations) that can be performed on the memory component 104 (e.g., a page read, a page program, a page erase, etc.) can comprise one or more writes and reads to the memory component 104 that can include both the transferring of data and the transferring of setup and/or configuration information to complete a transaction. Often times, conventional flash interfaces are specifically designed (via integrated into the flash interface design) to accommodate memory operations that can be performed with a memory component 104, for example. Further, conventional flash interfaces are often times designed to perform memory operations with only one or a select few types of memory components. As a result, traditional flash interfaces can be relatively rigid with regard to the type(s) of memory component(s) with which the flash interface can interface.

One of the advantages of the disclosed subject matter is that interactions between the flash interface component 102 and the memory component 104 can be software configurable. The micro-operations component 106 can be configured to contain one or more micro-operations. In accordance with one aspect of the disclosed subject matter, these micro-operations can be constructed into a command sequence that can be tailored to accommodate a specific memory component 104 such as, for example, one that complies with one or more flash interface standards (e.g., the ONFI standard). In another aspect, the micro-operations component 106 can be configured with a command sequence that can accommodate a memory component 104 that does not fully comply with such standards.

Another advantage of the disclosed subject matter is that a series of micro-operations (e.g., a command sequence) can be constructed and stored within the micro-operations component 106 that can be retrieved at a later time. For example, a library of command sequences can be accumulated to facilitate communicating with known memory component(s) 104. Depending on system requirements, the stored command sequences can be called multiple times, for example. Further, several command sequences can be constructed within the micro-operations component 106 and can be executed in any desired order. The ability to store one or more micro-operations or command sequences can provide the benefit of efficiently transferring data to and from the memory component 104 because a host (not shown) that can be associated with the flash interface component 102 can “fire-and-forget” one or more micro-operations or command sequences at a time, which can, for example, free the host to allow the host to perform other tasks.

In accordance with one aspect of the disclosed subject matter, the micro-operations component 106 can contain one or more micro-operations or command sequences to perform a page read memory operation associated with a first address or memory location within the memory component 104, for example. The micro-operations component 106 can also contain a command sequence to perform a page erase operation associated with a second address or memory location within the memory component 104, for example. It is to be appreciated that that the first address and the second address of the memory component 104 can be associated with the same physical address within the memory component 104 or associated with different addresses within the memory component 104. The micro-operations component 106 can provide the flexibility to either execute the command sequence (e.g., series of micro-operations) that facilitates the page read memory operation first or to execute the command sequence that facilitates the page erase memory operation first, for example. It is to be appreciated that additional device operations (e.g., an operation that performs a complete function associated with a memory component, such as a page erase, page write, page read, etc.) can be performed in a similar fashion wherein the micro-operations component 106 can contain the flexibility to have the memory operations performed in any order.

It is to be further appreciated that the micro-operations component 106 can contain one or more micro-operations to facilitate transactions associated with more than one memory component 104 as well. Further, the micro-operations component 106 can contain the flexibility to control the order in which the transactions occur. How the micro-operations component 106 and associated flash interface component 102 communicate with more than one memory component 104 is described herein in further detail with regard to system 200.

Referring back to the memory component 104, the memory component 104 can comprise nonvolatile memory and/or volatile memory, where such nonvolatile memory can include, but is not limited to, read-only memory (ROM), flash memory (e.g., single-bit flash memory, multi-bit flash memory), mask-programmed ROM, programmable ROM (PROM), Erasable PROM (EPROM), Ultra Violet (UV)-erase EPROM, one-time programmable ROM, electrically erasable PROM (EEPROM), and/or nonvolatile RAM (e.g., ferroelectric RAM (FeRAM), magnetoresistive RAM (MRAM)); and such volatile memory can include, but is not limited to, RAM, static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). In one aspect, a flash memory can be comprised of NAND memory and/or NOR memory, for example.

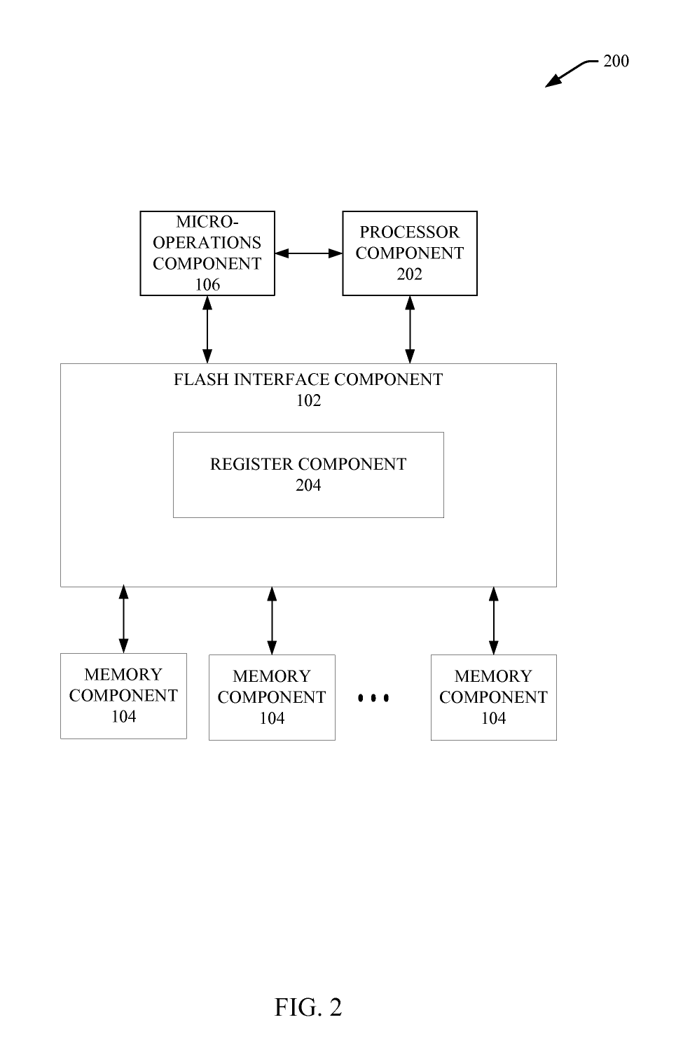

Referring to FIG. 2, depicted is a block diagram of a system 200 that can facilitate controlling data flow associated with a memory component in accordance with an aspect of the disclosed subject matter. System 200 can include a flash interface component 102 that can facilitate controlling data flow to and from a memory component 104. The flash interface component 102 can be associated with a processor component 202 that can be a typical applications processor that can handle communications and run applications, for example. The processor component 202 can be utilized by a computer, a mobile handset, PDA, or other electronic device, for example. The processor component 202 can also generate commands, including read, write, and/or erase commands, in order to facilitate reading data from, writing data to, and/or erasing data from the flash interface component 102 and/or the micro-operations component 106, for example. The processor component 202 can, for example, also instruct the micro-operations component 106 to transmit one or more command sequences to the flash interface component 102 via a bus. In one aspect, the communication of information between processor component 202, the micro-operations component 106, and/or the flash interface component 102 can be facilitated via the bus. The bus can include of any of several types of bus structure(s) including the memory bus or memory controller, a peripheral bus or external bus, and/or a local bus using any variety of available bus architectures including, but not limited to, Advanced Microcontroller Bus Architecture (AMBA), Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

In accordance with one aspect of the disclosed subject matter, the processor component 202 can process and assemble micro-operations associated with the micro-operations component 106. The micro-operations can be constructed into command sequences that can be programmed (e.g., stored) into a register component 204 via the bus. The register component 204 can store one or more command sequences, wherein the command sequences can facilitate writing, reading, programming, erasing, or a combination thereof, to the memory component 104 that can be associated with the flash interface component 102. In accordance with one aspect of the disclosed subject matter, the processor component 202 can facilitate storing four (or more) different command sequences from the micro-operations component 106, for example, into the register component 204. The command sequences can facilitate transactions to a memory component 104, wherein the transactions and/or which memory component 104 is being accessed can be based in part on the individual micro-operations contained within the respective command sequences.

In accordance with one aspect of the disclosed subject matter, system 200 can be associated with one or more memory component(s) 104. In one aspect, each command sequence can be associated with different memory component(s) 104. For example, a first command sequence can be constructed to facilitate one or more memory operations (e.g., page reads, page writes, page erases) associated with a first memory component 104, while a second command sequence can be constructed to facilitate one or more memory operations associated with a second memory component 104. Yet a third command sequence can be constructed to facilitate one or more memory operations associated with a third memory component 104, for example. It is to be appreciated that that the flash interface component 102 and the associated register component 204 can accommodate virtually any number of command sequences that can in turn accommodate virtually any number of memory component(s) 104.

By allowing one or more command sequences to be constructed to facilitate memory operations that can be associated with different memory component(s) 104, the disclosed innovation can allow for the execution of memory operations between the different memory components 104 to be executed in parallel. For example, a first command sequence associated with a first memory component 104 can be executed at the same time a second command sequence associated with a second memory component 104 is executed. In accordance with another aspect of the disclosed subject matter, the first command sequence, second command sequence, and a third command sequence associated with the first memory component 104, the second memory component 104, and a third memory component 104, respectively, can be executed at the same or substantially the same time (e.g., in parallel).

As a result, the parallel communication that can be facilitated by the processor component 202 and/or the micro-operations component 106 can significantly improve the overall data throughput to the memory component(s) 104. One or more of the memory component 104 can simultaneously or substantially simultaneously be accessed based in part on the command sequence(s) that can be constructed.

In accordance with one aspect of the disclosed subject matter, the command sequences for the plurality of memory component(s) 104 can be executed in an interleaving fashion. For example, a first command sequence associated with a first memory component 104 can be executed followed by a second command sequence associated with a second memory component 104. The interleaving of command sequences can, for example, allow for transactions associated with the first memory component 104 to occur prior to command sequences that can occur on the third memory component 104. As a result, the interleaving flexibility of the disclosed innovation can allow for the queuing of operations between memory component(s) 104 in which the transactions can be dependent upon the order in which they are executed.

It is to be appreciated that the inherent flexibility of the disclosed subject matter can also facilitate allowing individual command sequences to control data communications or memory operations to more than one memory component 104 in parallel as well. For example, instead of creating two separate command sequences to generate separate memory operations, a single command sequence can be generated to accommodate the two memory operations. It is to be appreciated that the two memory operations can be targeted to one memory component 104 or two or more separate memory component(s) 104, for example. This multi-dimensional flexibility (e.g., allowing separate command sequence to control separate memory component(s) 104 and allowing each command sequence to target separate memory component(s) 104) can facilitate preserving parallel and interleaving data communications between one or more memory component(s) 104 and the processor component 202 when a particular register component 204 does not have sufficient storage capacity to accommodate a high number of command sequences. For example, in one embodiment of the disclosed subject matter, a register component 204 may only be able to accommodate two command sequences wherein the flash interface component 102 can be associated with three or more memory component(s) 104. In such an instance, the disclosed innovation still can provide the ability to formulate command sequences to facilitate memory operations that can be associated with all of the memory component(s) 104 (e.g., three memory component(s) 104) associated with the flash interface component 102 as opposed to only two of the memory component(s) 104 associated with the flash interface component 102.

For instance, command sequences can, for example, be stored within the register component 204 (e.g., within hardware). Depending on what the requirements are for a particular flash interface component 102, the register component 204 can be designed to accommodate from only one to virtually any number of command sequences.

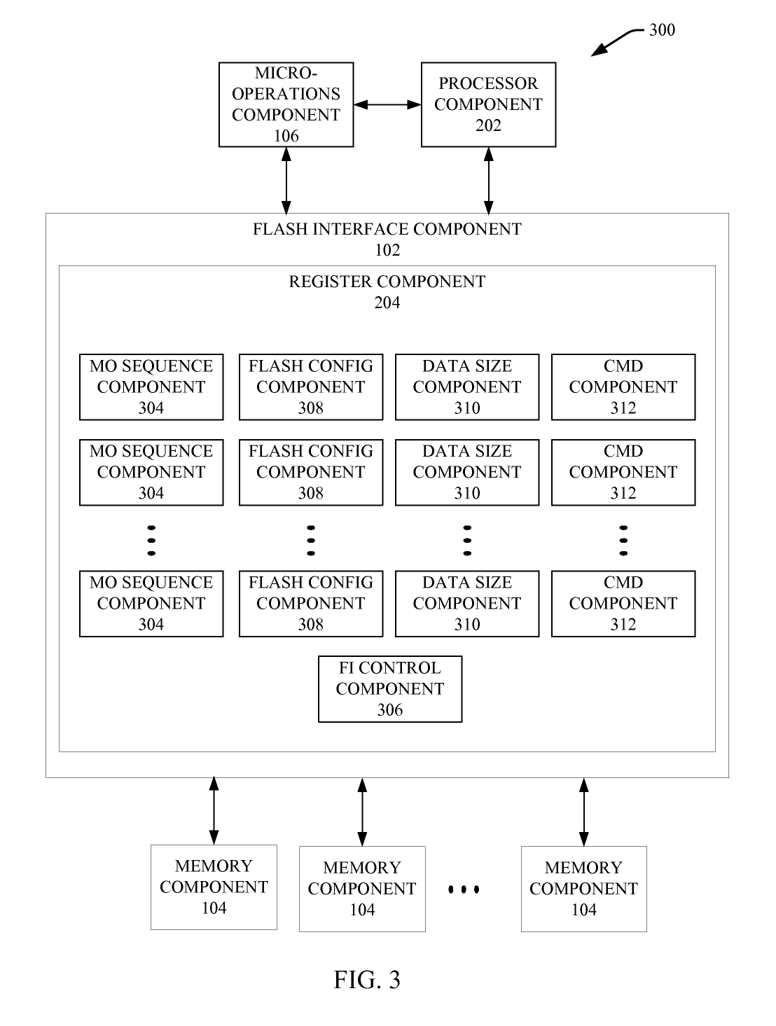

Turning to FIG. 3, illustrated is a system 300 that can facilitate the control of data to be transferred into a plurality of memory components in accordance with an embodiment of the disclosed subject matter. System 300 can include a flash interface component 102 that can facilitate controlling data flow to and from one or more memory component(s) 104. The system 300 can also include a processor component 202 that can be a typical applications processor that can handle communications and run applications that can be associated with the micro-operations component 106 and the flash interface component 102. For example, the processor component 202 can transfer micro-operations from the micro-operations component 106 to the flash interface component 102 wherein the micro-operations can be stored in one or more registers located within the register component 204. In another instance, the processor component 202 can instruct the micro-operations component 106 to transmit the micro-operations directly to the flash interface component 102 direct via a bus. It is to be appreciated that the flash interface component 102, register component 204, memory component 104, micro-operations component 106 and the processor component 202 can have the same or substantially same functionality as the respective components described herein, for example, with regard to system 100 and/or system 200.

In one embodiment of system 300, the register component 204 can include one or more MO (micro-operations) sequence component(s) 304. The MO sequence component 304 can be, for example, registers wherein the micro-operations component 106 can store the micro-operations (e.g., command sequences) via the processor component 202 or directly to the flash interface component 102 via a bus. Each MO sequence component 304 can contain one or more micro-operations, for example, that can control the communications between the flash interface component 102 and one or more of the memory component(s) 104. For example, the micro-operations component 106 can provide a first MO sequence component 304 with micro-operations that can instruct that a page read memory operation be performed on a first memory component 104 (e.g., a series of micro-operations that can be tailored directives for a page read operation to be performed on the first memory component 104). In one aspect, the micro-operations component 106 can also provide the first MO sequence component 304 with micro-operations that can instruct that an erase operation, for example, be performed on a second memory component 104 (e.g., a series of micro-operations that can be tailored directives for an erase operation to be performed on the second memory component 104 to perform an erase operation). In another aspect, the erase operation for the second memory component 104 can be stored in a second MO sequence component 304 instead.

It is to be appreciated that the disclosed subject matter contemplates that any number of MO sequence component(s) can be contained within the register component 204. For example, in one embodiment, only one MO sequence component 304 is contained within the register component 204, and in another embodiment, the register component 204 can contain two MO sequence component(s) 304. More MO sequence component(s) 304 can be designed into the register component 204 to accommodate storing additional micro-operations to control the one or more memory component(s) 104 associated with the flash interface component 102, for example.

In an embodiment wherein the register component 204 contains two or more MO sequence component(s) 304, the system 300 can also include a FI (flash interface) control component 306, wherein the FI control component 306 can be a multi-bit read-write register (e.g., 32-bit read-write register) that can manage the operation order of the one or more MO sequence component(s) 304. For example, the FI control 306 can contain information that allows for a first MO sequence component 304 to initiate executing the command sequence(s) contained within the first MO sequence component 304 either before or after a second MO sequence component 304 initiates executing the command sequence(s) contained in the second MO sequence component 304.

In one aspect, the FI control component 306 can also have a “start” or “go” bit associated with one of the bits contained therein. For example, a bit “0” (not shown) of the FI control component 306 can start the execution command sequences contained in one or more of the MO sequence component(s) 304. In accordance with one aspect of the disclosed subject matter, the MO sequence component 304 sequence information can be stored at the same time the “start” or “go” bit is triggered. Once the “start” or “go” bit is triggered, for example, the flash interface component 102 can begin execution of the command sequences contained in the one or more MO sequence component(s) 304 in the order specified by the FI control component 306, for example.

System 300 can also include one or more flash config (configuration) component(s) 308. The flash config component 308 can, for example, be a multi-bit read-write register (e.g., 32-bit read-write register) that can be used to store configuration information about the one or more memory component(s) 104. For instance, the flash config component 308 can contain such information as the data width of a specific memory component 104. In one aspect, the flash interface component 102 can use information contained in the flash config component 308 to determine the optimal width of data that can be sent and received to a memory component 104. For example, the micro-operation contained in a MO sequence component 304 can call for a read operation to be performed on a memory component 104. When the read micro-operation is executed, information contained in the FI control component 306 (e.g., the data width associated with the memory component 104 from which data is to be read) can be obtained to facilitate the read operation. For example, a memory component 104 that can only accommodate data that is 8 bits wide can require twice as many data write operations as a memory component 104 that can accommodate a data width of 16 bits wide, and the flash interface component 102 can adjust data transfers to one or more of the memory component 104 based in part on the information that can be contained in the flash config component 308. It is to be appreciated that the disclosed subject matter also contemplates that other information such as the size of a memory component 104, for example, can be contained within the flash config component 308 as well.

In one embodiment of the disclosed subject matter, the system 300 can also include one or more data size component(s) 310. The data size component 310 can be, for example, a multi-bit register (e.g., 32-bit register) that can store information concerning how many bytes the flash interface component 102 can read from or write to a memory component 104 for a read (RXD) or write (TXD) micro-operation. The data size value contained in the data size component 310 can be set before a command sequence contained in a MO sequence component 304 is executed, for example. In one embodiment, the data size value contained in the data size component 310 can decrease automatically (e.g., be decremented) as a data read or a data write to a memory component 104 is performed.

In one embodiment of the disclosed subject matter, the system 300 can also include one or more cmd (command) component(s) 312. It is to be appreciated that a memory component 104 can have one or more commands that can be specific to the type of device the memory component 104 is. The commands can, for example, be associated with setup and/or configuration aspects of a specific memory component 104. In one aspect, each cmd component 312 can be, for example, a multi-bit register (e.g., 32-bit register) that can be used to store these commands for one or more of the memory component(s) 104. The commands associated with a cmd component 312 can be set before a command sequence contained in a MO sequence component 304 is executed, for example. Once a command sequence is initiated, one of the micro-operations contained within the command sequence can request that the value (e.g., the command) contained in the cmd component 312 be sent to a particular memory component 104, for example.

The disclosed subject matter contemplates that the system 300 can also include other register components not specifically depicted herein as well. For example, the system 300 can also include a status register component (not shown) that can provide such information as what stage a given command sequence is at during execution and/or whether a particular memory component 104 is busy, for example. The disclosed subject matter can, for example, also include an interrupt register (not shown). An interrupt register can, for example, indicate whether an interrupt has been triggered within the flash interface component 102. For example, a micro-operation can be executed to set one or more interrupt bits of the interrupt register.

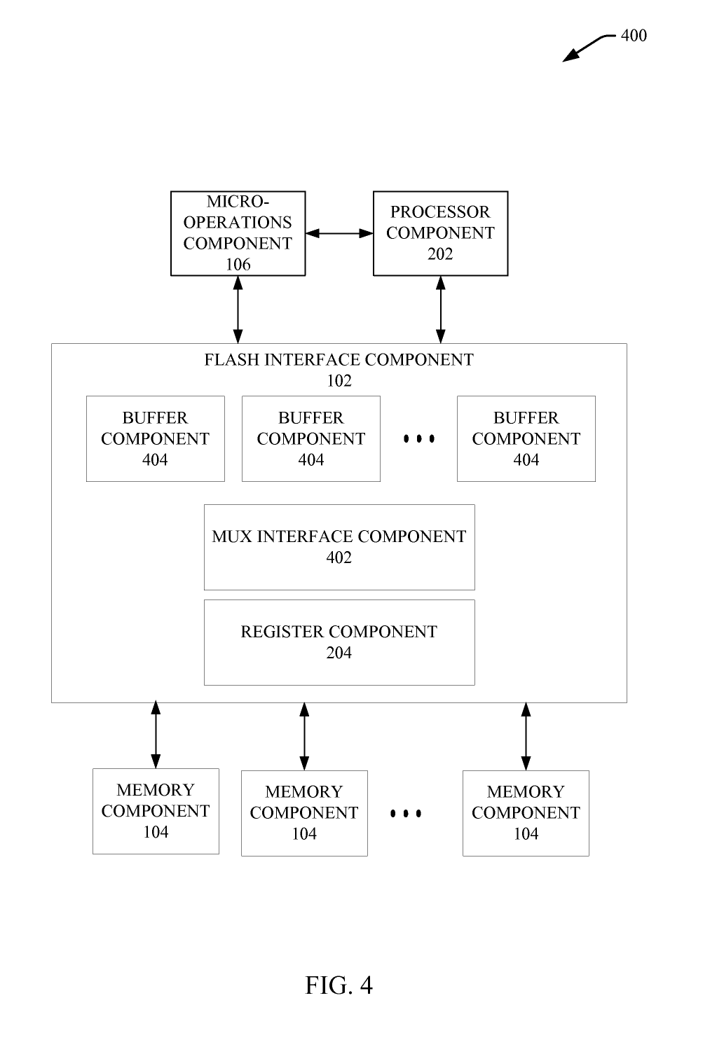

Referring to FIG. 4, illustrated is system 400 that can facilitate buffering data from one or more memory components in accordance with an embodiment of the disclosed subject matter. The system 400 can include a mux interface component 402. The mux interface component 402 can effectuate switching between one or more memory component(s) 104 during micro-operation reads (RXD) and micro-operation writes (TXD) to and from one or more of the memory component(s) 104. In order to facilitate fast data transfers, the system 400 can also include one or more buffer component(s) 404. The buffer component(s) 404 can be a single or double-port RAM, SRAM, or other type of volatile or nonvolatile memory, for example. The buffer component 404 can be used for temporary storage of the programming data (e.g., associated with a TXD micro-operation) from a bus (not shown) (e.g., an AHB bus) associated with the processor component 202 or saving data from (e.g., associated with an RXD micro-operation) one or more of the memory component(s) 104.

In one aspect of the disclosed subject matter, a buffer component 404 can be used to store data that can be received during a read micro-operation (e.g., an RXD) from one or more of the memory component(s) 104. In another aspect, a buffer component 404 can be used to store data that can be sent to a memory component 104 during a write micro-operation (e.g., a TXD) to one or more of the memory component(s) 104.

After an MO sequence component (e.g., MO sequence component 304 of FIG. 3) begins executing a command sequence (e.g., by setting a “start” or “go” bit associated with a FI control component 306 as described in FIG. 3) the flash interface component 102 can analyze the command sequence, and then execute micro-operations one-by-one. The flash interface component 102 can stop the operation if an end of sequence (EOS) command is encountered or when all of the command sequences have been executed, depending on how many MO sequence component 304 are to be triggered (e.g., depending on the configuration of the FI control component 306 in FIG. 300). During the execution of the one or more of the command sequences, the mux interface component 402 can facilitate the directing of traffic from or to one or more of the buffer component(s) 404 during data reads or data writes to the memory component(s) 104, for example.

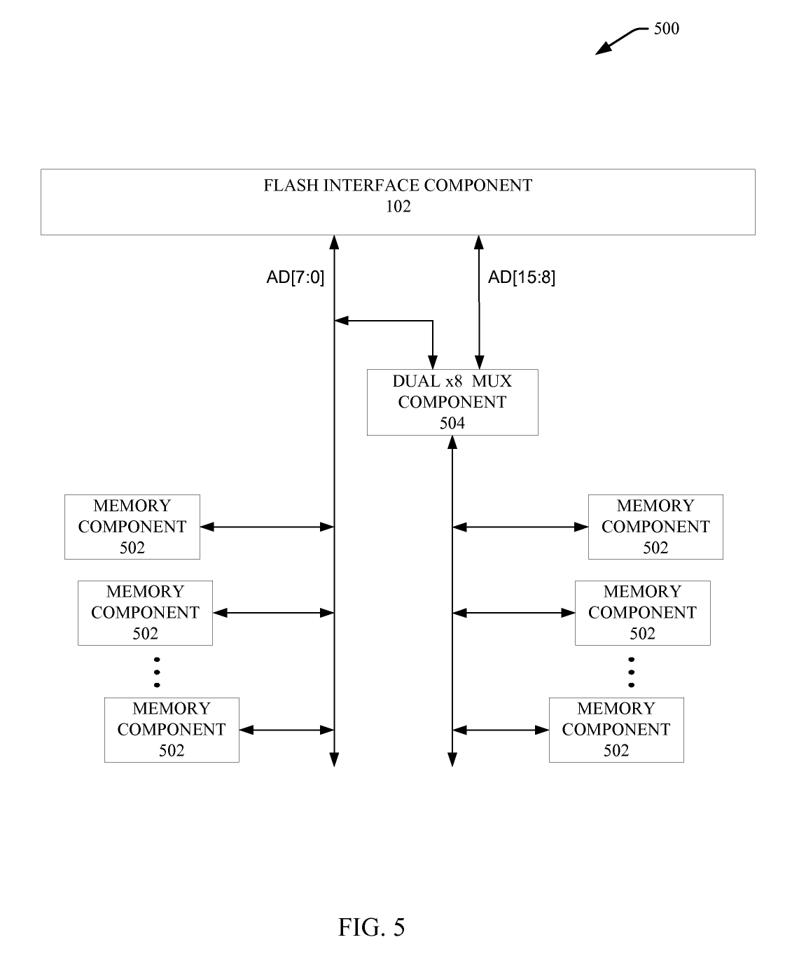

Referring to FIG. 5, illustrated is a system 500 a block diagram of a system that can facilitate the control of data to be transferred to a plurality of memory components in accordance with an embodiment of the subject matter. System 500 can include a flash interface component 102 that can that can facilitate sending and receiving data and commands to a plurality of memory components 502. It is to be appreciated that the memory components 502 each can be the same or similar as, and/or can contain the same or similar functionality as, respective components, such as memory component 104, as more fully described herein, for example, with regard to system 100, system 200, system 300, and/or system 400. Also, it is to be appreciated that the flash interface component 102, can be the same or similar as, and/or can have the same or similar functionality as, respective components described herein, for example, with regard to system 100, system 200, system 300, and/or system 400.

The system 500 can facilitate expedient data transfers with memory component(s) 502 that can, for example, be associated with a data bus that can be eight bits wide, wherein the flash interface component 102 can simultaneously transfer data to two memory components 502 (hereinafter also referred to as “Dual x8 Mode”). In one aspect (e.g., as depicted in FIG. 5), the flash interface component 102 can be associated with a sixteen bit wide address/data bus (e.g., as shown by the “AD[7:0]” and “AD[15:8]”), wherein a portion of the bus (e.g., “AD[7:0]”) can be used to facilitate transferring data to a number of the memory components 502 associated with the flash interface component 102 and the another portion of the bus (e.g., “AD[15:8]”) can be used to facilitate communicating with the other memory components 502 that can be associated with the flash interface component 102.

It is to be appreciated that the Dual x8 Mode can be enabled and the flash interface component 102 can be configured to operate simultaneous or substantially simultaneous read and/or write operations to two or more memory components 502 in the Dual x8 Mode. For example, the FI control component 306 of FIG. 3 can contain control information that can enable the Dual x8 Mode and control whether eight memory components 502 or sixteen memory components 502 can be associated with the flash interface component 102. It is to be appreciated that enabling the Dual x8 Mode and the configuration for a Dual x8 Mode (e.g., the number of memory components 502 that are associated with a flash interface component 102 operating in the Dual x8 Mode) can be stored in other registers associated with system 300 as well.

The system 500 can also include a dual x8 mux component 504, wherein the dual x8 mux component 504 can control whether the lower eight bits of an address/data bus (e.g., “AD[7:0]”) associated with the flash interface component 102, for example, can be presented to a predetermined number of memory components 502. For example, if the Dual x8 Mode is enabled (e.g., via a control signal stored in an IF control component 306 of FIG. 3 or other storage component), the dual x8 mux component 504 can present the upper eight bits (e.g., “AD[15:8]”) of the address/data to four of the memory components 502 (e.g., the odd numbered memory components 502).

In accordance with one aspect of the disclosed subject matter, the Dual x8 Mode can, for example, support eight memory components 502 or sixteen memory components 502, wherein the flash interface component 102 can simultaneously transmit and/or receive data to two of the eight or sixteen memory components 502 simultaneously or substantially simultaneously (e.g., memory components 502 that can be associated with an eight bit-wide data bus). In one aspect, if the flash interface component 102 operating in the Dual x8 Mode is associated with sixteen memory components 502, for example, one of eight chip selects (not shown) can control enabling two of the sixteen memory components 502 during data transfers, wherein each of the two memory components 502 (e.g., the two memory components 502 that can be simultaneously enabled by a single chip select) can simultaneously or substantially simultaneously transmit and/or receive identical commands and/or data. By allowing two memory components 502 (e.g., memory components 502 that can be associated with 8 bit-wide buses) to be controlled by a single chip select, the throughput of the flash interface component 102 can double (e.g., two memory components 502 that share a single chip select can be programmed concurrently). In addition, the amount of data storage/density (e.g., memory components 502 with eight bit-wide buses) associated with the flash interface 102 can double as well.

In accordance with another aspect of the disclosed subject matter, if the flash interface component 102 operating in a Dual x8 Mode is associated with eight memory components 502, for example, each of the memory components 502 can be enabled with individual chip selects (not shown). In this aspect, a user can, for example, setup two command sequences (e.g., by placing the command sequences into to two different MO sequence components 304 as described in system 300) to program two memory components 502 independently (e.g., receive and/or transmit data to two memory components 502 simultaneously). In accordance with one aspect of the disclosed subject matter, a “start” or “go” bit within the FI control component 306 can be set to trigger the command sequences stored in the MO sequence components 304 to facilitate simultaneous (or nearly simultaneous) communication with two of the memory components 502.

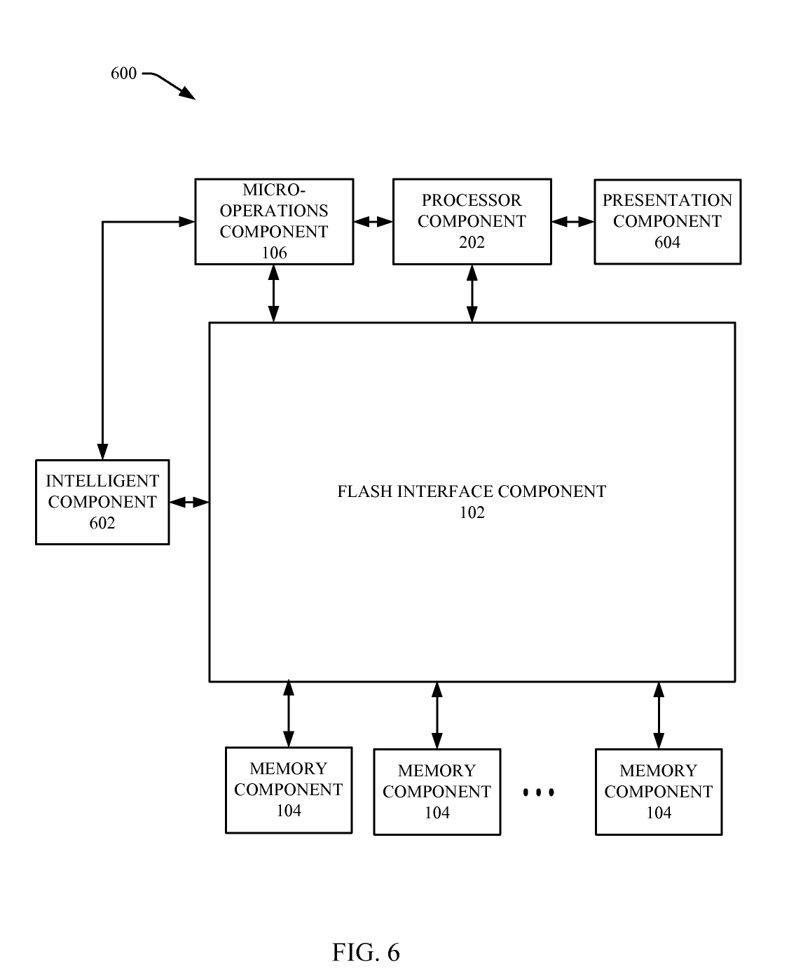

Turning to FIG. 6, depicted is a system 600 that can employ intelligence to facilitate transmission of data to a plurality of memory components in accordance with an aspect of the disclosed subject matter. System 600 can include a processor 202 and micro-operations component 106. The micro-operations component 106 can contain software configurable micro-operations that can facilitate communicating with one or more of the memory component(s) 104. The software configurable micro-operations stored in the micro-operations component 106 can be conveyed to a flash interface component 102 via the processor component 202 or directly to the flash interface component 102 via a bus, for example. The flash interface component 102, the micro-operations component 106, and the memory component(s) 104 each can be substantially similar to respective components and can include such respective functionality as more fully described herein, for example, with regard to system 100, system 200, system 300, system 400, and/or system 500.

The system 600 can further include an intelligent component 602 that can be associated with the micro-operations component 106 and the flash interface component 102, and can analyze data, and based in part on such data, can make an inference(s) and/or a determination(s) regarding a the frequency at which a memory component 104 can operate, the data width associated with a memory component 104, or other specific information regarding the memory component(s) 104 and the flash interface component 102, for example. For example, the intelligent component 602 can evaluate current (e.g., query information) and/or historical information associated with a memory component 104, and based in part on such information and/or predefined criteria, can make an inference as to an optimal frequency for data transfers between the flash interface component 102 and the memory component 104.

As another example, during a program operation, the intelligent component 602 can analyze current and/or historical information associated with a memory component 104 to be programmed and can infer that the memory component 104 can accommodate command (CMD) memory operations that are different than CMD memory operations typically associated with a standard protocol (e.g., the ONFI standard), and can communicate such inference to the micro-operations component 106, which can structure CMD memory operations that can facilitate efficient transmission of data from the flash interface component 102 and the memory component 104.

It is to be understood that the intelligent component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data (e.g., historical data), whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the disclosed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

System 600 also can include a presentation component 604 that can present data associated with the processor component 202. It is to be appreciated that the presentation component 604 can be incorporated into the processor component 202 and/or a stand-alone unit. The presentation component 604 can provide various types of user interfaces to facilitate interaction between a user and any component coupled to the processor component 202.

The presentation component 604 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled to and/or incorporated into the processor component 202.

The user can also interact with the regions to select and provide information via various devices such as a mouse, a roller ball, a keypad, a keyboard, a pen and/or voice activation, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

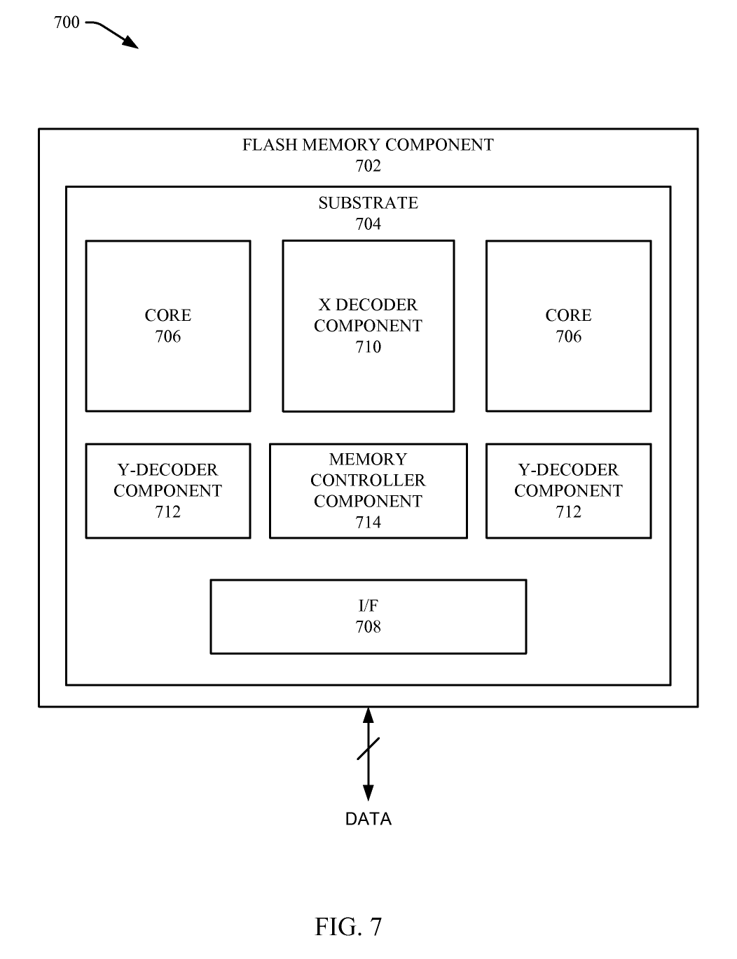

Referring to FIG. 7, illustrated is a block diagram of a system 700 that can facilitate storage of data in accordance with an aspect of the disclosed subject matter. In accordance with an aspect, the system 700 can be or can include a flash memory component 702, which can be, for example, one or more memory component(s) 104 and/or memory components 502 described herein in regards to system 100, system 200, system 300, system 400, system 500, and/or system 600. The flash memory component 702 can be created on a semiconductor substrate 704 in which one or more core regions 706, which can be higher-density core regions, and one or more peripheral regions, which can be lower-density regions, can be formed. The high-density core regions 706 can include one or more M by N arrays of individually addressable, substantially identical multi-bit memory cells (not shown). The memory cells in memory device 702 can retain stored data even while disconnected from a power source.

The lower-density peripheral regions can typically include an interface component 708 (hereinafter also referred to as “I/F 708”) that can interface to a flash interface component (e.g., flash interface component 102 in FIG. 1, FIG. 2, FIG. 3, etc.) and programming circuitry for selectively addressing the individual memory cells. The programming circuitry can be represented in part by and can include one or more x-decoders 710 and one or more y-decoders 712 that can cooperate with the I/F 708 for selectively connecting a source, gate, and/or drain of selected addressed memory cells to predetermined voltages or impedances to effect designated operations (e.g., programming, reading, erasing) on the respective memory cells, and deriving necessary voltages to effect such operations. Further, the I/F 708 can include and/or provide various adapters, connectors, channels, communication paths, etc. to integrate the system 700 into virtually any operating and/or database system(s) and/or with another system(s). In addition, I/F 708 can provide various adapters, connectors, channels, communication paths, etc., that can provide for interaction and/or communication with other components, data, and the like, associated with the system 700.

System 700 can also include a memory controller component 714 that can facilitate control of the flow of data to and from the flash memory component 702. In one aspect, the memory controller component 714, by itself or in conjunction with a processor (e.g., processor component 202 of FIG. 2), can facilitate execution of micro-operations operations that can facilitate such memory operations as an RXD, TXD, and/or a CMD associated with memory locations in the core(s) 706. In another aspect, the memory controller component 714 can facilitate verifying and/or maintaining the desired charge level(s) associated with data stored in the memory locations in the core(s) 706. In accordance with one embodiment of the disclosed subject matter, each of the one or more of the memory component(s) 104 can be or can include the flash memory component 702.

The aforementioned systems have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

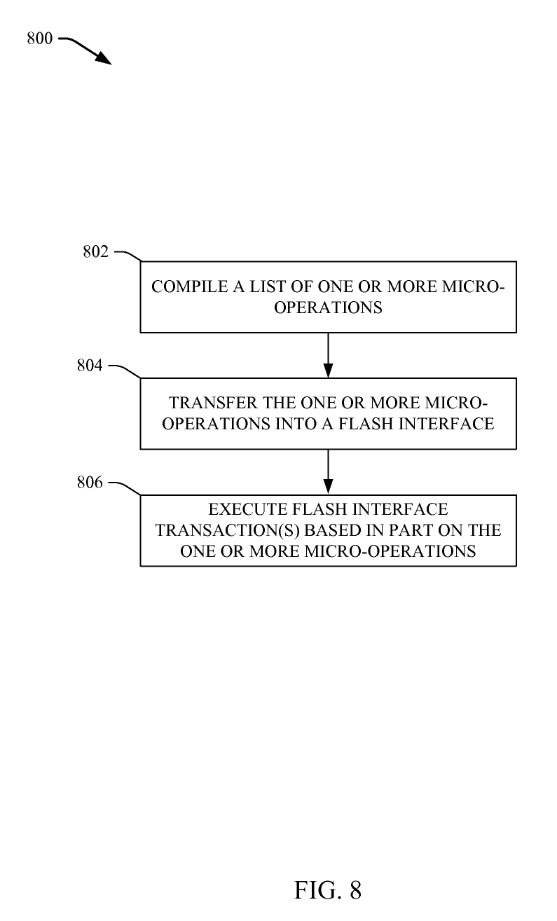

FIGS. 8-10 illustrate methodologies and/or flow diagrams in accordance with the disclosed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring to FIG. 8, a methodology 800 that can facilitate controlling flash interface component data flow in accordance with an aspect of the disclosed subject matter is illustrated. At 802, a list of micro-operations can be compiled or organized. In accordance with one aspect of the disclosed subject matter, a micro-operations component (e.g., micro-operations component 106 of FIG. 1) can contain several or a series of micro-operations that can be performed to communicate with one or more memory components (e.g., memory component(s) 104 of FIG. 1, memory components 502 FIG. 5). The micro-operations can be formulated into command sequences that can perform operations (e.g., memory operations such as page erases, page writes, and/or page reads) that can be performed on the memory components. The command sequences can include transferring of data and/or configuration information to complete a transaction, for example.

Each micro-operation can represent a command given to a flash interface component (e.g., flash interface component 102 of FIG. 1, FIG. 2, FIG. 3, etc.) to perform a task. The micro-operations can represent such tasks as, but not limited to, sending a command to the memory component (e.g., a CMD micro-operation), sending a row address to the memory component, sending a column address to the memory component, transmitting data to the memory component (e.g., TXD micro-operation), to receive data from the memory component (e.g., RXD), having the flash interface component (e.g., flash interface component 102 of FIG. 1) wait for a ready signal from the memory component, sending an interrupt request (IRQ) to a processor (e.g., processor component 202 of FIG. 2), reading a status register from the memory component, and providing an end of sequence indication to the flash interface component (EOS) to indicate the last micro-operation has occurred.

At 804, the compiled list of one or more micro-operations can be transferred into a flash interface component. For example, the one or more micro-operations that can be contained in the micro-operations component 106 can be transferred to a flash interface component (e.g., flash interface component 102 of FIGS. 1 and 2) via a processor (e.g., processor component 202 of FIG. 2) or can be transferred directly to the flash interface component 102, wherein the one or more micro-operations can be stored in registers (e.g., MO sequence component 304 of FIG. 3). In one embodiment, one or more command sequences can be created to simultaneously or substantially simultaneously communicate with two memory components (e.g., memory components 502 of FIG. 5) while the flash interface component operates in a Dual x8 Mode (e.g., as described in system 500).

The micro-operations can remain in the registers (e.g., MO sequence component 304) while, at 806, the flash interface component can execute flash interface component transactions based in part on the one or more micro-operations. For example, the processor component 202 can start the execution of the micro-operations by setting a “start” or “go” bit that can be associated with a control register (e.g., FI control component 306 of FIG. 3). The flash interface component can, for example, continue to execute the one or more micro-operations that were transferred to the registers until an EOS (end of sequence) micro-operation is encountered. At this point, methodology 800 can end.

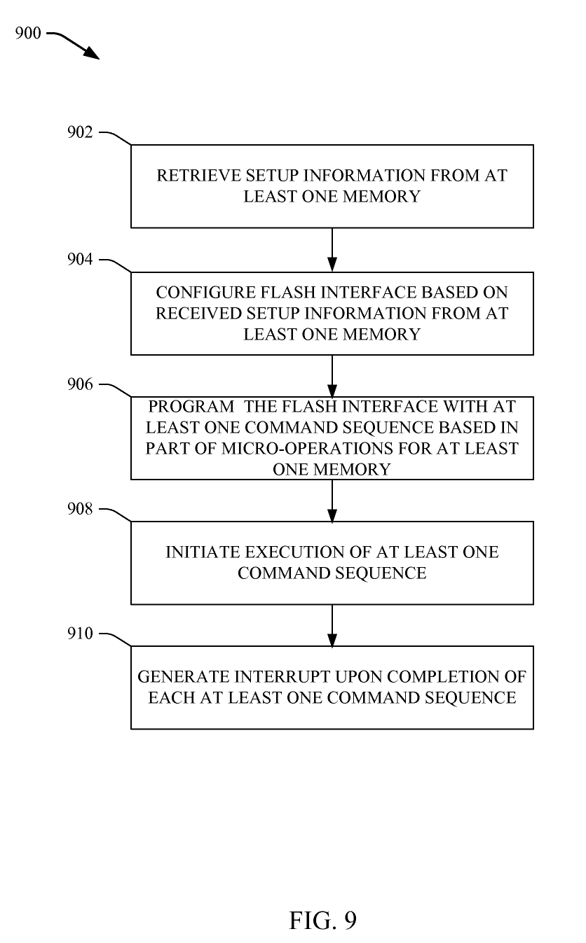

FIG. 9 depicts a methodology 900 that facilitates programming a flash interface component based in part on memory component setup information in accordance with an aspect of the disclosed subject matter. At 902, setup information can be retrieved from at least one memory component. For instance, a flash interface component (e.g., flash interface component 102 of FIG. 2) can receive setup information (e.g., a parameter page) from one or more memory components (e.g., memory component(s) 104 of FIGS. 1 and 2 and/or memory components 502 of FIG. 5). The setup information can contain such information as, for example, timing and data widths associated with a respective memory component.

At 904, the flash interface component (e.g., flash interface component 102 of FIG. 2) can be configured based on the setup information received from the one or more memory components. In accordance with one aspect of the disclosed subject matter, setup information such as the data width associated with a memory component 104 can be stored in a register (e.g., flash config component 308 of FIG. 3). The setup information can, for example, be used by the flash interface component 102 to facilitate the execution of a command sequence (e.g., a string of one or more micro-operations) associated with the memory component 104 with which the setup information can be associated.

At 906, the flash interface component can be programmed with at least one command sequence that can be based in part on micro-operations for at least one memory associated with the flash interface component. For example, at least one command sequence can be sent from the micro-operations component 106 via the processor component 202 to the flash interface component 102. In another example, the processor component 202 can instruct the micro-operations component 106 to send the at least one command sequence to be sent to the flash interface component 102 via a bus that can connect the micro-operations component 106 and the flash interface component 102. The flash interface component 102 can store the command sequences into one or more sequence registers (e.g., MO sequence component(s) 304 of FIG. 3). The command sequence can remain in the MO sequence component(s) 304 until the MO sequence component(s) 304 are either reprogrammed or until the flash interface component 102 finishes the execution of the at least one command sequence.

At 908, the execution of the at least one command sequences can be initiated. In accordance with one aspect of the disclosed subject matter, a micro-operations component (e.g., micro-operations component 106 of FIG. 1), a processor (e.g., processor component 202 of FIG. 2) or a combination thereof can write to a register within the flash interface component (e.g., flash interface component 102 of FIGS. 1 and 2). For example, the flash interface component can contain a register (e.g., FI control component 306 of FIG. 3) that can have a “start” or “go” bit associated with one of the bits contained therein. For example, writing a “1” to bit “0” associated with the register can start the execution of at least one command sequences contained in one or more sequence registers (e.g., MO sequence component(s) 304 of FIG. 3), wherein the sequence registers can store the at least one command sequence.

In accordance with one aspect of the disclosed subject matter, more than one command sequence can be configured and initiated in parallel to facilitate transactions with one or more memory components (e.g., memory component(s) 104 of FIG. 2) associated with the flash interface component. For example, a first command sequence associated with a first memory (e.g., a first memory component 104 of FIG. 2) can be executed at the same time a second command sequence that can be associated with a second memory (e.g., a second memory component 104 of FIG. 2) is executed.

Upon the completion of each of the at least one command sequence, the flash interface component can generate an interrupt (IRQ) (e.g., the interrupt register as illustrated in FIG. 3 and described herein) that can be propagated to a processor (e.g., processor component 202 of FIG. 2) to indicate that the each of the at least one command sequence has finished. In one aspect, the command sequence can be constructed to generate an IRQ as well. At this point, methodology 900 can end.

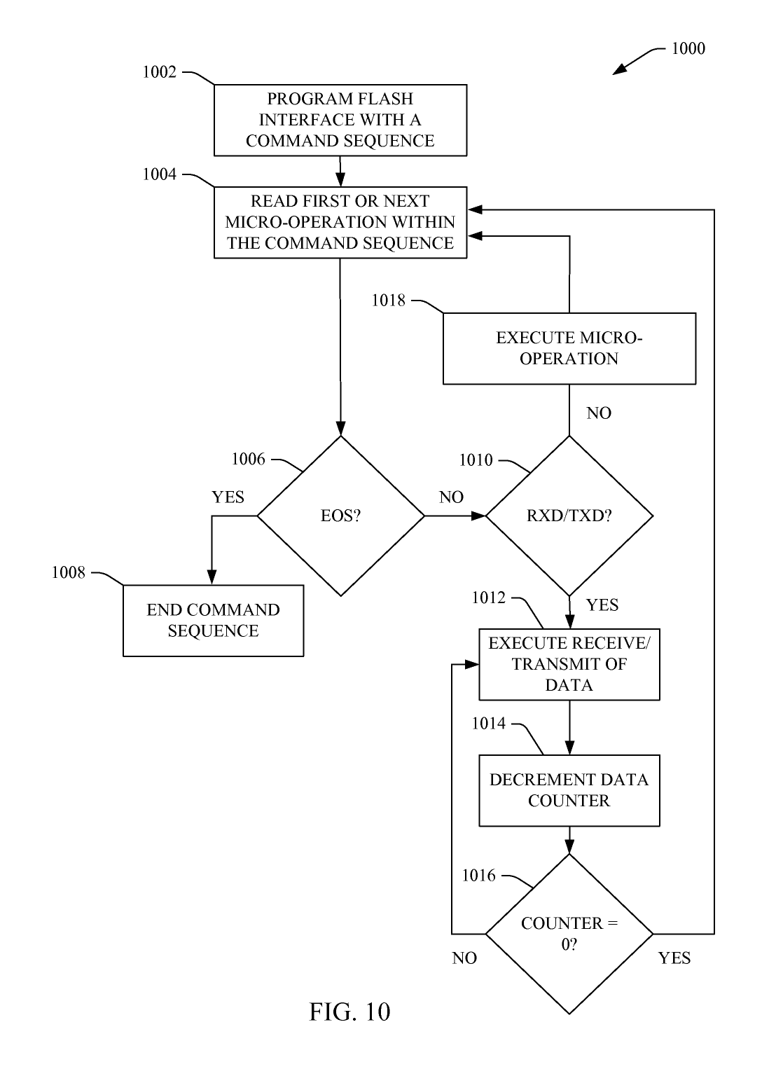

FIG. 10 depicts a methodology 1000 that can facilitate transferring data to a memory component in accordance with an aspect of the disclosed subject matter. At 1002, a flash interface component (e.g., flash interface component 102 of FIG. 2) can be programmed with a command sequence. It is to be appreciated that that more than one command sequence can be programmed and executed within methodology 1000 to facilitate parallel data transmissions to and from one or more memory components (e.g., memory component(s) 104 of FIG. 2); however, for brevity, only one such command sequence is described herein with regard to methodology 1000. In accordance with one aspect of the disclosed subject matter, a processor (e.g., processor component 202 of FIG. 2) can retrieve a command sequence from a micro-operations component (e.g., micro-operations component 106 of FIG. 1). In another aspect, the micro-operations component 106 can send a command sequence directly to the flash interface component 102 directly via a bus that can connect the micro-operations component 106 and the flash interface component 102. The processor can, for example, can facilitate storing the command sequence into one or more sequence registers (MO sequence component 304 of FIG. 3) that can be contained in the flash interface component.

It is to be appreciated that the inherent flexibility of the disclosed subject matter can also facilitate having two or more executions of methodology 1000 starting at 1002 wherein each of the executions of methodology 1000 can be performed at the same or substantially the same time (e.g., in parallel or an interleaved manner); however, it is to be appreciated that, for brevity, only one such execution is depicted in FIG. 10. For example, a command sequence that can be contained in a first MO sequence component (e.g., MO sequence component 304) can be started and proceed in accordance with methodology 1000 while a second command sequence contained in a second MO sequence component (e.g., MO sequence component 304) can be started and can proceed in accordance with methodology 1000 at the same or substantially same time (e.g., in parallel). In accordance with one aspect of the disclosed subject matter, the second command sequence contained in the second MO sequence component can be started at any time during which a first command sequence contained in a first MO sequence component is being executed, for example.

At 1004, the flash interface component can read the first or next micro-operation associated with the command sequence. The reading of the first or next micro-operation can facilitate preparing the flash interface component to execute the operation the micro-operation is requesting to be performed.

At 1006, a determination can be made as to whether the next micro-operation is an end of sequence (EOS) micro-operation. If it is determined that the next micro-operation is an EOS, at 1008, the command sequence can end.

Returning back to reference number 1006, if it is determined that the next micro-operation is not an EOS, at 1010, a determination can be made as to whether the next micro-operation associated with the command sequence is a receive (RXD) or a transmit (TXD) micro-operation command. If it is determined that the micro-operation is an RXD or a TXD command, at 1012, the flash interface component can facilitate the execution of a data receive or data transmit associated with a memory component (e.g., memory component 104 of FIG. 2).

At 1014, the flash interface component can decrement a data counter (e.g., data size component 310 of FIG. 3) when data is sent to or received from the memory component. In accordance with one aspect of the disclosed subject matter, the data counter can be preloaded with the number of data transfers that can be associated with a given data receive or data transfer associated with a memory component.

At 1016, a determination can be made regarding whether the value contained within the data counter has reached zero. If it is determined that the data counter has not reached zero, methodology 1000 can return to reference numeral 1012, and the flash interface component can execute another data receive or data transmit to the memory component. Data can continue to be received or transmitted (e.g., as depicted in reference numbers 1012, 1014, and 1016) until, at 1016, it is determined that the data counter (e.g., data size component 310 of FIG. 3) reaches a value of zero. Once it is determined, at 1016, that the data counter reaches a value of zero, methodology 1000 can return to reference numeral 1004, and the flash interface component can read the next micro-operation associated with the command sequence.

Referring back to reference number 1010, if it is determined that the first or next micro-operation is not an RXD or a TXD micro-operation, at 1018, the flash interface component can execute the micro-operation. In accordance with one aspect of the disclosed subject matter, the micro-operation can be, for example, to send a command to a memory component (e.g., a CMD micro-operation), wherein the command can be a command specific to particular memory component associated with the flash interface component that can be stored in a command register (e.g., cmd component 312 of FIG. 3). In accordance with another aspect of the disclosed subject matter, the micro-operation can be a command that instructs the flash interface component to wait for a ready signal from one or more of the memory component(s) that can be associated with the flash interface component. In accordance with yet another aspect, the micro-operation can be a command for the flash interface component to send an interrupt (IRQ) to a processor (processor component 202 of FIG. 2), for example. Once the flash interface component executes the micro-operation, methodology 1000 can return to reference numeral 1004, and the flash interface component can read the first or next micro-operation in the command sequence. Methodology 1000 can continue from that point to execute micro-operations, until, at 1006, it is determined that the micro-operation is an EOS micro-operation. If, at 1006, it is determined that the micro-operation is an EOS micro-operation, at 1008, the command sequence can end.

It is to be appreciated that the disclosed subject matter contemplates that virtually any number of micro-operations can be associated with a micro-operations component (micro-operations component 106 of FIG. 1) that can be programmed into the flash interface component 102. At this point, methodology 1000 can end.

As utilized herein, terms “component,” “system,” “interface,” and the like, are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

Furthermore, the disclosed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the disclosed subject matter.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

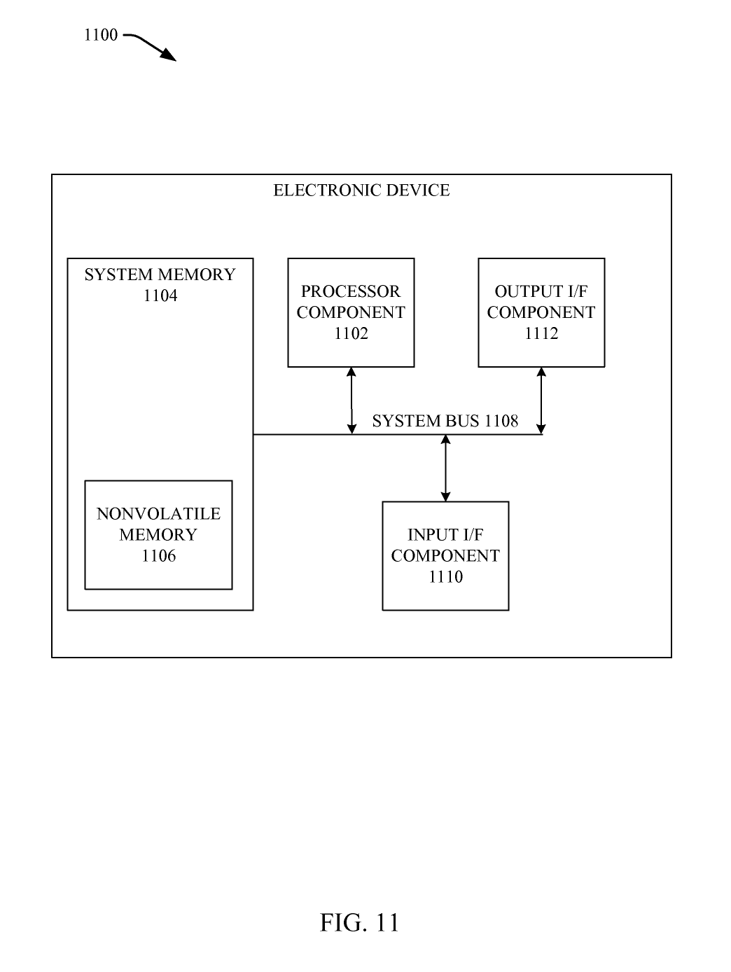

In order to provide a context for the various aspects of the disclosed subject matter, FIG. 11 as well as the following discussion are intended to provide a brief, general description of a suitable environment(s) in which the various aspects of the disclosed subject matter may be implemented. While the subject matter has been described above in the general context of computer-executable instructions of a computer program that runs on a computer and/or computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., PDA, phone, watch), microprocessor-based or programmable consumer or industrial electronics, and the like. The illustrated aspects may also be practiced in distributed computing environments where tasks are performed by remote processing devices that are linked through a communications network. However, some, if not all aspects of the claimed innovation can be practiced on stand-alone computers. In a distributed computing environment, program modules may be located in both local and remote memory storage devices.

Referring to FIG. 11, illustrated is a block diagram of an exemplary, non-limiting electronic device 1100 that can utilize one or more of the memory component(s) (e.g., memory component(s) 104, as illustrated in FIGS. 1 and 2, and described herein) as depicted in system 100, system 200, system 300, system 400, and/or system 600, or a respective portion(s) thereof. The electronic device 1100 can include, but is not limited to, a computer, a laptop computer, network equipment (e.g., routers, access points), a media player and/or recorder (e.g., audio player and/or recorder, video player and/or recorder), a television, a smart card, a phone, a cellular phone, a smart phone, an electronic organizer, a PDA, a portable email reader, a digital camera, an electronic game (e.g., video game), an electronic device associated with digital rights management, a Personal Computer Memory Card International Association (PCMCIA) card, a trusted platform module (TPM), a Hardware Security Module (HSM), set-top boxes, a digital video recorder, a gaming console, a navigation system or device (e.g., global position satellite (GPS) system), a secure memory device with computational capabilities, a device with a tamper-resistant chip(s), an electronic device associated with an industrial control system, an embedded computer in a machine (e.g., an airplane, a copier, a motor vehicle, a microwave oven), and the like.

Components of the electronic device 1100 can include, but are not limited to, a processor component 1102 (e.g., which can be and/or can include the same or similar functionality as processor component 202, as depicted in FIG. 2 and described herein), a system memory 1104, which can contain a nonvolatile memory 1106 (e.g., which can be and/or include the same or similar functionality as the memory component 104 as depicted in FIG. 1, and described herein), and a system bus 1108 that can couple various system components including the system memory 1104 to the processor component 1102. The system bus 1108 can be any of several types of bus structures including a memory bus or memory controller, a peripheral bus, or a local bus using any of a variety of bus architectures.

Electronic device 1100 can typically include a variety of computer readable media. Computer readable media can be any available media that can be accessed by the electronic device 1100. By way of example, and not limitation, computer readable media can comprise computer storage media and communication media. Computer storage media includes volatile and non-volatile, removable and non-removable media implemented in any method or technology for storage of information such as computer readable instructions, data structures, program modules or other data. Computer storage media includes, but is not limited to, RAM, ROM, EEPROM, nonvolatile memory 1106 (e.g., flash memory), or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by electronic device 1100. Communication media typically embodies computer readable instructions, data structures, program modules or other data in a modulated data signal such as a carrier wave or other transport mechanism and includes any information delivery media.

The system memory 1104 can include computer storage media in the form of volatile (e.g., SRAM) and/or nonvolatile memory 1106 (e.g., flash memory). For example, nonvolatile memory 1106 can be the same or similar, or can contain the same or similar functionality, as memory component 104 (e.g., as described with regard to system 100), memory component 502 (e.g., as described with regard to system 500), and/or flash memory component 702 (e.g., as described with regard to system 700). A basic input/output system (BIOS), containing the basic routines that can facilitate transferring information between elements within electronic device 1100, such as during start-up, can be stored in the system memory 1104. The system memory 1104 typically also can contain data and/or program modules that can be accessible to and/or presently be operated on by the processor component 1102. By way of example, and not limitation, the system memory 1104 can also include an operating system(s), application programs, other program modules, and program data.

The nonvolatile memory 1106 can be removable or non-removable. For example, the nonvolatile memory 1106 can be in the form of a removable memory card or a USB flash drive. In accordance with one aspect, the nonvolatile memory 1106 can include flash memory (e.g., single-bit flash memory, multi-bit flash memory), ROM, PROM, EPROM, EEPROM, or NVRAM (e.g., FeRAM), or a combination thereof, for example. Further, a flash memory can comprise NOR flash memory and/or NAND flash memory.

A user can enter commands and information into the electronic device 1100 through input devices (not shown) such as a keypad, microphone, tablet, or touch screen although other input devices can also be utilized. These and other input devices can be connected to the processor component 1102 through input interface component 1110 that can be connected to the system bus 1108. Other interface and bus structures, such as a parallel port, game port or a universal serial bus (USB) can also be utilized. A graphics subsystem (not shown) can also be connected to the system bus 1108. A display device (not shown) can be also connected to the system bus 1108 via an interface, such as output interface component 1112, which can in turn communicate with video memory. In addition to a display, the electronic device 1100 can also include other peripheral output devices such as speakers (not shown), which can be connected through output interface component 1112.

What has been described above includes examples of aspects of the disclosed subject matter. It is, of course, not possible to describe every conceivable combination of components or methodologies for purposes of describing the disclosed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has,” or “having,” or variations thereof, are used in either the detailed description or the claims, such terms are intended to be inclusive in a manner similar to the term “comprising” as “comprising” is interpreted when employed as a transitional word in a claim.

What is claimed is:

1. A system that facilitates a data transaction associated with at least one memory component, comprising:
micro-operations component, wherein the micro-operations component contains at least one micro-operation; and
a flash interface component wherein the flash interface component executes one or more of the at least one micro-operation associated with the micro-operations component.

2. The system of claim 1, wherein the flash interface component can be programmed to execute the at least one micro-operation in at least one predetermined order.

3. The system of claim 1, wherein the at least one micro-operation includes a command to transmit data (TXD) to the at least one memory component, to receive data (RXD) from the at least one memory component, to send a command to and is associated with the at least one memory component, to issue an address cycle to send a row address to the at least one memory component, to issue a cycle to send a column address to the at least one memory component, to have the flash interface component wait for a ready signal from the at least one memory component, to generate an interrupt request (IRQ), to read a status register from the at least one memory component, to provide an end of sequence (EOS) indication to the flash interface component or a combination thereof.

4. The system of claim 1, further comprising a processor component, wherein the processor component facilitates assembling the at least one micro-operation contained in the micro-operations component and/or facilitates transferring the at least one micro-operation to the flash interface component.

5. The system of claim 1, wherein the at least one memory component comprises flash memory.

6. The system of claim 1, wherein the at least one micro-operation is assembled into at least one command sequence wherein the flash interface component executes the at least one command sequence to facilitate data transactions with the at least one memory component.

7. The system of claim 1, the at least one memory component comprises a plurality of memory components and the at least one micro-operation comprises a plurality of micro-operations, wherein the flash interface component executes micro-operations respectively associated with at least two memory components of the plurality of memory components to facilitate data transfers to the at least two memory components to facilitate parallel data transfers to the at least two memory components at substantially the same time.

8. The system of claim 1, wherein the at least one micro-operation interleaves the execution of at least one flash interface transaction associated with the at least one memory component.

9. The system of claim 9, further comprising:
at least one buffer component associated with the flash interface component; and
a mux interface component associated with the flash interface component, wherein the mux interface component directs data between the at least one buffer component and the at least one memory component when the flash interface component executes one or more of the at least one micro-operation associated with the micro-operations component.

10. The system of claim 1, further comprising a register component associated with the flash interface component, wherein the register component stores information to facilitate the execution of the at least one micro-operation.

11. The system of claim 10, further comprising:
at least one MO sequence component wherein the at least MO sequence component stores the at least one micro-operation; and
an FI control component wherein the FI control component facilitates the MO sequence component order of execution within the flash interface component; and
at least one flash config component wherein the at least one flash config component stores information associated with the at least one memory component, wherein the flash interface component utilizes the information associated with the at least one memory component stored in the at least one flash config component to execute the at least one micro-operation.

12. The system of claim 10, further comprising at least one data size component where in the at least one data size component is programmed with a data count value, wherein the data count value represents the number of data transactions associated with the at least one micro-operation, wherein the data count value is automatically decremented for each data transaction.

13. The system of claim 9, further comprising at least one cmd component, wherein the at least one cmd component can be preprogrammed with a command associated with the at least one memory component, wherein the flash interface component transmits the command associated with the at least one memory component to execute the at least one micro-operation.

14. An electronic device comprising the system of claim 1.

15. The electronic device of claim 14, wherein the electronic device is at least one of a smart card, a computer, a laptop computer, network equipment, a media player, a media recorder, a television, a phone, a cellular phone, a smart phone, an electronic organizer, a personal digital assistant, a portable email reader, a digital camera, an electronic game, an electronic device associated with digital rights management, a Personal Computer Memory Card International Association (PCMCIA) card, a trusted platform module (TPM), a Hardware Security Module (HSM), a set-top box, a digital video recorder, a gaming console, a navigation device, a secure memory device with computational capabilities, a device with at least one tamper-resistant chip, an electronic device associated with industrial control systems, or an embedded computer in a machine, or a combination thereof, wherein the machine comprises one of an airplane, a copier, a motor vehicle, or a microwave oven.

16. A method that facilitates controlling data transactions with at least one memory component, comprising:
constructing a list of at least one micro-operation;
transferring the list of at least on micro-operation to flash interface component; and
executing flash interface component transactions associated with the at least one memory component based in part on the at least one micro-operation.

17. The method of claim 16, further comprising:
retrieving setup information from the at least one memory component;
configuring the flash interface component based in part on the setup information from the at least one memory component to facilitate the act of executing the flash interface component transactions associated with the at least one memory component based in part on the at least one micro-operation.

18. The method of claim 16, wherein the act of executing the flash interface component transactions associated with the at least one memory component based in part on the at least one micro-operation comprises at least one of:
transmitting data (TXD) to the at least one memory component,
receiving data (RXD) from the at least one memory component,
sending a command to the at least one memory component,
issuing an address cycle to send a row address to the at least one memory component,
issuing a cycle to send a column address to the at least one memory component,
issuing a command to have the flash interface component wait for a ready signal from the at least one memory component,
generating an interrupt request (IRQ) to a processor associated with the flash interface component,
reading a status register from the at least one memory component, or
providing an end of sequence (EOS) indication to the flash interface component, or a combination thereof.

19. The method of claim 16, further comprising decrementing at least one data counter associated with the at least one micro-operation, wherein the act of executing the flash interface component transactions associated with the at least one memory component based in part on the at least one micro-operation includes at least one of:
transmitting data (TXD) to the at least one memory component, or
receiving data (RXD) from the at least one memory component, or a combination thereof.

20. The method of claim 16, further comprising:
creating at least one command sequence based in part on the at least one micro-operation; and
generating an interrupt upon the completion of the at least one command sequence.
